(19) United States
(12) Patent Application Publication
(10) Pub. No.: US 2022/0365746 A1
(43) Pub. Date: Nov. 17, 2022

(54) GENERATING A VISUAL REPRESENTATION OF A SOUND CLIP

(71) Applicant: Ford Global Technologies, LLC, Dearborn, MI (US)

(72) Inventors: Joy Mountford, Mountain View, CA (US); Melissa Kim, Los Altos, CA (US)

(73) Assignee: Ford Global Technologies, LLC, Dearborn, MI (US)

(21) Appl. No.: 17/320,204

(22) Filed: May 13, 2021

(51) Int. Cl. G06F 3/16; G06F 3/0481

(52) U.S. Cl. CPC G06F 3/167; G06F 3/04817

(57) ABSTRACT

The disclosure generally pertains to systems and methods for generating visual symbols that uniquely identify various sounds. An example method to generate a visual symbol can involve identifying a sound and assigning quantization values to various attributes of the sound. In an example implementation, a numerical template is used to assign a quantization value to each attribute. A set of such quantization values constitute a graphical representation that can be designated as a visual symbol of the sound. In an example application, the quantization values corresponding to the visual symbol can be stored in a memory along with quantization values corresponding to other visual symbols of other sounds. The memory may then be used for various purposes such as, for example, to perform a search for sounds that are similar to a desired sound.

### BACKGROUND

It is often difficult for a person to accurately describe a sound to another person who has not heard the sound before. Typically, the other person may try to interpret the description of the sound based on his/her past exposure to other sounds. Thus, for example, if a sound is described as “booming,” a first person may hear this word and interpret the description based on his/her past experience of hearing a lightning strike during a thunderstorm, a second person may interpret the same word based on his/her past experience at a music concert venue, and a third person, may interpret the same word based on his/her past experience of hearing a dynamite explosion at a construction site.

It is therefore desirable to provide a way by which a sound can be characterized in a more consistent and reliable manner. It is further desirable that such a characterization be provided in a format that can be operated upon by a computer for performing various types of actions.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example scenario where an object produces a sound that can be converted into a visual symbol in accordance with the disclosure.

FIG. 2 shows a first example template that may be used to characterize a sound in accordance with an embodiment of the disclosure.

FIG. 3 shows a second example template that may be used to characterize a sound in accordance with an embodiment of the disclosure.

FIG. 4 illustrates a third example template that may be used to produce an averaged visual symbol in accordance with an embodiment of the disclosure.

FIG. 5 shows a flowchart of a method to generate a visual symbol of a sound in accordance with an embodiment of the disclosure.

FIG. 6 shows a flowchart of a method to search a memory for a visual symbol of a sound in accordance with an embodiment of the disclosure.

### DETAILED DESCRIPTION

Overview

In terms of a general overview, this disclosure is directed to systems and methods to generate visual symbols that uniquely identify various sounds. An example method to generate a visual symbol can involve identifying a sound and assigning quantization values to various attributes of the sound. In an example implementation, a numerical template is used to assign a quantization value to each attribute. A set of such quantization values constitute a graphical representation that can be designated as a visual symbol of the sound. In an example application, the quantization values corresponding to the visual symbol can be stored in a memory along with quantization values corresponding to other visual symbols of other sounds. The memory may then be used for various purposes such as, for example, to perform a search for sounds that are similar to a desired sound.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases that are used herein should be interpreted as referring to various objects and actions that are generally understood in various forms and equivalencies by persons of ordinary skill in the art. For example, the phrase “psychological stimulant” as used herein is applicable to any of various attributes present in sound. The word “sound” as used herein refers to any of various types of sounds such as, for example, a sound clip, a sound snippet, a sound segment, a sound made by a first object coming in contact with a second object, a sound made by a moving object, a sound produced through a loudspeaker, a snippet from a song, a snippet of music, and/or a digital representation of a sound signal (as produced by an analog-to-digital converter device, for example). The phrase “In an example implementation” as used herein must be understood as an abbreviated version of the phrase “In an example implementation in accordance with the disclosure.” It should be understood that the word “example” as used herein is intended to be non-exclusionary and non-limiting in nature.

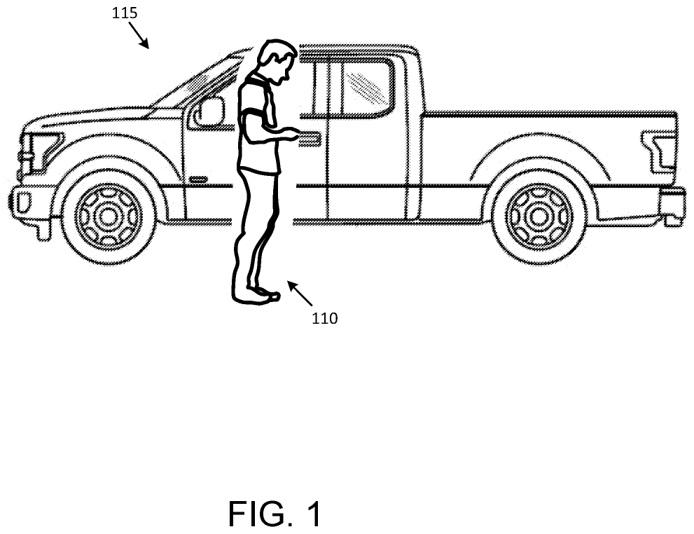

FIG. 1 illustrates an example scenario where an object produces a sound that can be converted into a visual symbol in accordance with the disclosure. In this example scenario, the object that produces the sound is a vehicle 115. In other scenarios, various other objects can produce various types of sounds that can be interpreted by one or more individuals for generating various visual symbols in accordance with the disclosure.

Sound associated with the vehicle 115 can be any of various types of sounds such as, for example, a sound produced when a door is closed, a sound produced when a lid of a trunk is closed, a sound produced when a lid of an engine compartment is closed, a sound of a chime when a door is opened, a sound of an engine revving, or a voice announcement produced through an infotainment system. Each of such sounds can be a sound clip, a sound burst, a sound snippet, or a sound segment. In an example application, a duration of such sounds is less than three minutes. However, in other applications, the procedures disclosed herein are equally applicable to sounds extending over longer durations, including, for example, a song or a musical arrangement.

In the example scenario illustrated in FIG. 1, a sound is produced when an individual 110 closes a door of the vehicle 115. In one case, the vehicle 115 may be a luxury sedan that includes doors incorporating various types of acoustic materials for dampening sound. Consequently, the sound produced by the door being closed has a first set of sound attributes. In another case, the vehicle 115 may be a utility truck that includes heavy metal doors with less acoustic material. The sound produced by the door being closed in this case has a second set of sound attributes that is different than the first set of attributes.

The individual 110 may, for example, be a vehicle enthusiast who recognizes the difference in attributes and instinctively associates the first set of attributes with a luxury vehicle and the second set of attributes with a utility truck. The individual 110 may attempt to describe these differences to some other person (not shown) by way of some descriptive words such as, for example, “a muffled thump,” or “a soft closure” of the door of the luxury vehicle and “a metallic thunk,” or “a hard thud” of the door of the truck. The other person may try to interpret the description based on his/her past exposure to various types of sounds such as, for example, a door of a building being closed or a door of a bank vault being shut. Such an interpretation may be inadequate in some cases and inaccurate in some other cases. Furthermore, it may be challenging to use such qualitative descriptions to instruct a computer to perform certain operations such as, for example, a search for a sound that is similar to the sound produced by the door of the luxury sedan, or to execute a comparative analysis between the sound produced by the door of the luxury sedan and a sound produced by a door of a building. It is therefore desirable to provide a way to characterize a sound by quantifying various sound attributes of the sound in accordance with the disclosure. The phrase “psychological stimulant” as used herein encompasses these various sound attributes.

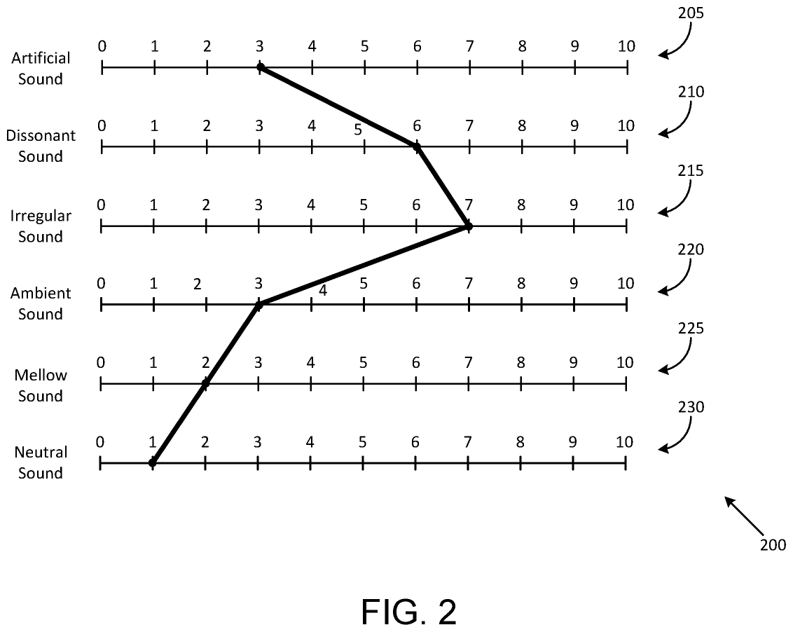

FIG. 2 shows a first example template 200 that may be used to characterize a sound by quantifying various sound attributes in accordance with an embodiment of the disclosure. The template 200 is a numerical template that can include two or more scales such as, for example, a scale 205, a scale 210, a scale 215, a scale 220, a scale 225, and a scale 230. Each scale extends over a range of numerical values. In the example implementation shown in FIG. 2, each scale extends from 0 to 10. In another example implementation, each scale may extend from 1 to 100. In yet another example implementation, each scale may include positive as well as negative values such as, for example, from −10 to +10.

The number of scales included in the template 200 can correspond to a number of psychological stimulants present in a sound. The nature and the number of psychological stimulants can vary in accordance with the sound being characterized, and/or by an entity performing the characterization (a vehicle manufacturer or a music producer, for example). For example, a sound produced by a single sound source (a component of a vehicle, an individual, a single musical instrument, etc.) may be characterized by fewer psychological stimulants than a sound produced by multiple sound sources in a concurrent manner (an orchestra, ambient street sounds, a sound of a radio heard over engine noise in a vehicle, etc.). Some other example psychological stimulants can be defined by words such as melody (dissonant to harmonic, for example), rhythm (irregular to rhythmic, for example), texture (number of instruments or layers of sound, artificial to natural, generally all the binaries), structure/form (categorizations of music or sounds like sonatas vs pop songs, for example), expression (mellow to energized, negative to positive, for example), context (demographic of listeners, time of day, associated environments where the music or sound would be played, or moods during which the music or sound would be played, for example).

In an example implementation, the template 200 may be displayed upon a display screen of a computer. An individual who is performing a characterization of a sound snippet (or any other type of sound) by use of the template 200, may indicate a selection on each scale by placement of a cursor (either by operating a mouse or via a touch-screen action). The scale 205 of the template 200 is associated with a first psychological stimulant that is labeled as an artificial sound. The individual may assign a first quantization value to the first psychological stimulant based on his/her perception of the sound snippet as having an artificial sound quality (such as would be produced by a music synthesizer, for example). A numerical value of 10 would indicate that the individual perceives the sound snippet as sounding highly artificial. Lower numerical values indicate lower levels of artificiality. In this example, the individual assigns a first quantization value of 3.

The scale 210 of the template 200 is associated with a second psychological stimulant that is labeled as a dissonant sound. The individual who is performing the characterization of the sound snippet may assign a second quantization value to the second psychological stimulant based on his/her perception of the sound snippet as having a dissonant sound quality (such as would be produced by a door slam, for example). A numerical value of 10 would indicate that the individual perceives the sound snippet as sounding highly dissonant (with lower numbers indicating lower levels of dissonance). In this example, the individual assigns a second quantization value of 6.

The scale 215 of the template 200 is associated with a third psychological stimulant that is labeled as an irregular sound. The individual who is performing the characterization of the sound snippet may assign a third quantization value to the third psychological stimulant based on his/her perception of the sound snippet as having an irregular sound quality (such as would be produced by an engine being started, for example). A numerical value of 10 would indicate that the individual perceives the sound snippet as sounding highly irregular (with lower numbers indicating lower levels of irregularity). In this example, the individual assigns a third quantization value of 7.

The scale 220 of the template 200 is associated with a fourth psychological stimulant that is labeled as an ambient sound. The individual who is performing the characterization of the sound snippet may assign a fourth quantization value to the fourth psychological stimulant based on his/her perception of the sound snippet as having an ambient sound quality (such as associated with elevator music, for example). A numerical value of 10 would indicate that the individual perceives the sound snippet as sounding highly ambient (with lower numbers indicating lower levels of ambience). In this example, the individual assigns a fourth quantization value of 3.

The scale 225 of the template 200 is associated with a fifth psychological stimulant that is labeled as a mellow sound. The individual who is performing the characterization of the sound snippet may assign a fifth quantization value to the fifth psychological stimulant based on his/her perception of the sound snippet as having a mellow sound quality (such as would be produced by a chime in a vehicle, for example). A numerical value of 10 would indicate that the individual perceives the sound snippet as sounding highly mellow (with lower numbers indicating lower levels of mellowness). In this example, the individual assigns a fifth quantization value of 2.

The scale 230 of the template 200 is associated with a sixth psychological stimulant that is labeled as a neutral sound. The individual who is performing the characterization of the sound snippet may assign a sixth quantization value to the sixth psychological stimulant based on his/her perception of the sound snippet as having a negative sound quality (such as would be produced by a strident siren, for example). A numerical value of 10 would indicate that the individual perceives the sound snippet as sounding highly negative (with lower numbers indicating lower levels of negativity). In this example, the individual assigns a sixth quantization value of 1.

Various action icons and/or messages may be displayed on the display screen of the computer to allow the individual to carry out additional operations such as, for example, to review, edit, amend, and accept his/her selections performed upon the template 200. When the individual has accepted his/her selections, the computer may produce a graphical representation of the sound snippet based on the selected quantization values. In an example implementation, the computer may connect the selected quantization values using linear segments to produce the graphical representation illustrated in FIG. 2. In another example implementation, the computer may connect the selected quantization values using non-linear segments to produce a curved graphical representation.

The computer may then designate the graphical representation as a visual symbol of the sound snippet, and store the visual symbol in a memory. In an example implementation, the visual symbol may be stored in the memory in the form of quantization values designated on the template 200 for the various psychological stimulants. The stored quantization values for the visual symbol in this example can be 367321. In some cases, a label may be attached to the stored visual symbol in the form of a file name.

In a first example use of the stored visual symbol, a user of the computer may enter a query into the computer to locate and retrieve the visual symbol. The query may include the entire number 367321 or a part of the number 367321 together with a file name, for locating and retrieving the visual symbol. In another example operation, the user may desire to identify one or more other sounds that sound similar to the sound snippet associated with the visual symbol. The query in this case, may be formatted as 367*, where * indicates a wild card search. The computer may respond to the query by displaying all visual symbols that begin with 367. Other such numerical values may be used to carry out other types of searches. For example, a search for an ambient, mellow sound may be initiated by entering a query such as, for example, 32*. The computer may respond to the query by displaying all visual symbols that include a quantization value 3 for the ambient psychological stimulant and a quantization value 2 for the mellow psychological stimulant.

In another example implementation, the visual symbol may be stored in the memory in the form of coordinate values for rendering the visual symbol upon the display screen of the computer. A user of the computer may observe the visual symbol and perform various operations such as, for example, visually comparing the shape of the visual symbol with shapes of other visual symbols displayed upon the display screen. The comparing may be carried out, for example, in order to identify other sounds that sound similar to the sound snippet associated with the displayed visual symbol.

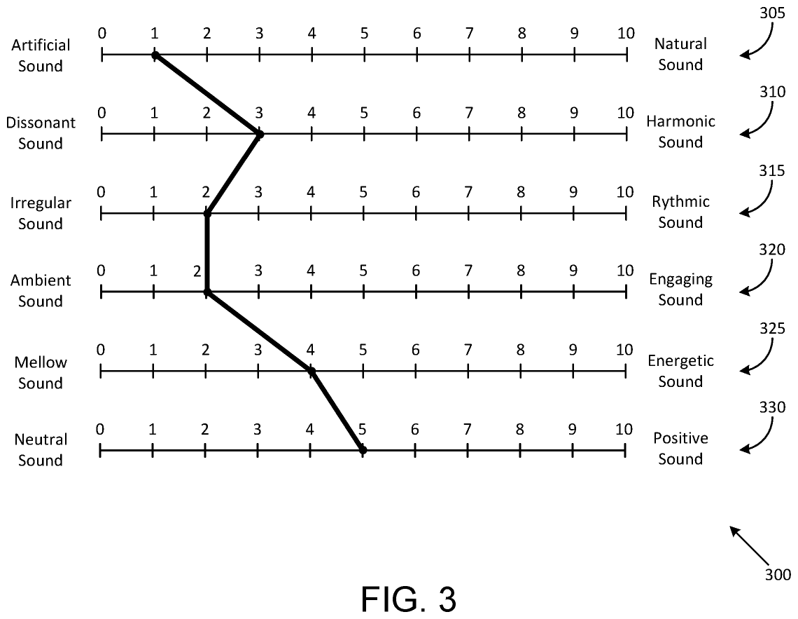

FIG. 3 shows a second example template 300 that may be used to characterize a sound in accordance with an embodiment of the disclosure. The various scales of the template 300 resemble those of the template 200 in terms of the functionality and numerical values associated with each scale. However, each scale of the template 300 offers a comparative evaluation between two types of psychological stimulants. A first set of psychological stimulants displayed to the left of the numerical scales correspond to the psychological stimulants shown in the template 200. A second set of psychological stimulants displayed to the right of the numerical scales correspond to various psychological stimulants that may contrast in sound perception with those of the first set of psychological stimulants.

More particularly, the template 300 includes a scale 305 that allows a user of the computer upon which the template 300 is displayed to select a quantization value for a psychological stimulant that can range from an artificial sound to a natural sound. A numerical value of 0 indicates a psychological stimulant that is highly artificial and a numerical value of 10 indicates a psychological stimulant that is highly natural, with values in between ranging in grade from highly artificial to highly natural.

An individual who is performing the characterization of a sound snippet (or any other type of sound) by use of the template 300 may assign a first quantization value to the first psychological stimulant. The first quantization value can be a numerical value based on his/her perception of the sound snippet as having an artificial sound quality (such as would be produced by a music synthesizer). A numerical value of 10 would indicate that the individual perceives the sound snippet as sounding highly artificial (with lower numbers indicating lower levels of artificiality). In the illustrated example, the individual who is performing the characterization assigns a quantization value of 1 upon the scale 305 because the individual perceives the sound segment to have a first psychological stimulant that is largely artificial.

The template 300 further includes a scale 310 that allows the individual who is performing the characterization of the sound snippet (or any other type of sound) by use of the template 300 to assign a second quantization value to a psychological stimulant that can range from dissonant to harmonic. The individual may then assign a quantization value of 3 upon the scale 310 because the individual perceives the sound segment to have a second psychological stimulant that is somewhat dissonant.

The template 300 further includes a scale 315 that allows the individual to assign a third quantization value to a psychological stimulant that can range from irregular to rhythmic. The individual may then assign a quantization value of 2 upon the scale 315 because the individual perceives the sound segment to have a third psychological stimulant that is somewhat irregular.

The template 300 further includes a scale 320 that allows the individual to assign a fourth quantization value to a psychological stimulant that can range from ambient to engaging. The individual may then assign a quantization value of 2 upon the scale 320 because the individual perceives the sound segment to have a fourth psychological stimulant that is quite ambient.

The template 300 further includes a scale 325 that allows the individual to assign a fifth quantization value to a psychological stimulant that can range from mellow to energetic. The individual may then assign a quantization value of 4 upon the scale 325 because the individual perceives the sound segment to have a fifth psychological stimulant that is somewhat mellow.

The template 300 further includes a scale 330 that allows the individual to assign a sixth quantization value to a psychological stimulant that can range from neutral to positive. The individual may then assign a quantization value of 2 upon the scale 330 because the individual perceives the sound segment to have a sixth psychological stimulant that is somewhat negative.

The entries made into the template 300 may be acted upon in ways such as those described above with respect to template 200. For example, various action icons and/or messages may be displayed on the display screen of the computer to allow the individual to carry out additional operations such as, for example, to review, edit, amend, and accept his/her selections performed upon the template 300. When the individual has accepted his/her selections, the computer may connect the selected quantization values to produce a graphical representation of the sound snippet, which may be designated as a visual symbol of the sound snippet. The visual symbol may be stored in memory and used in various ways such as the ones described above.

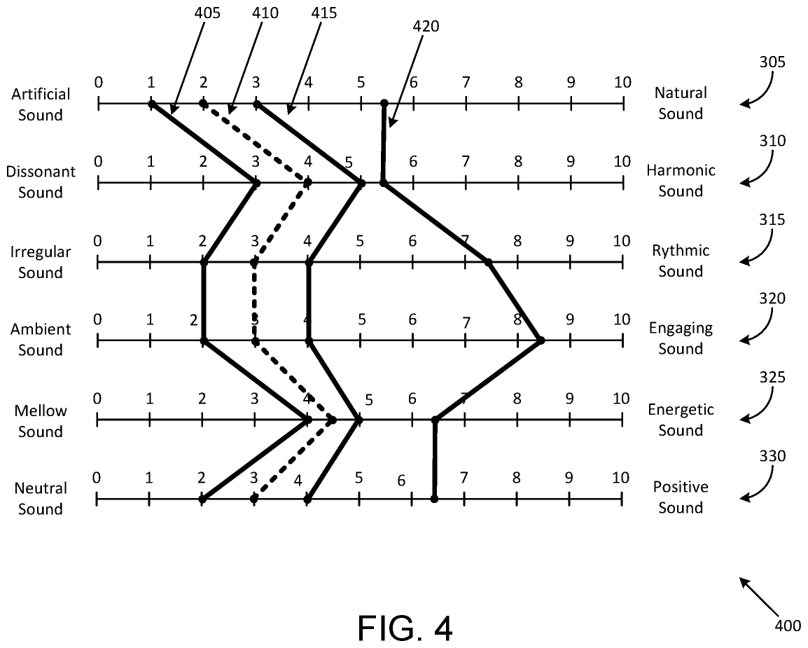

FIG. 4 illustrates the template 400 that may be used to produce an averaged visual symbol in accordance with an embodiment of the disclosure. The description provided above with respect to FIG. 3 discloses a procedure where a single individual uses the template 300 to create a visual symbol of a sound snippet. In some scenarios, a visual symbol created by a first individual may not necessarily reflect how other individuals perceive the sound snippet. Consequently, the template 400 may be used to produce a visual symbol of a sound snippet based on input obtained from “n” (n≥2) individuals.

The visual symbol 405 is the visual symbol produced by the first individual using the method described above. A second individual may use the same procedure described above to produce a visual symbol 415 based on how he/she perceives the timber components in the same sound segment that the first individual listened to for creating the visual symbol 405. A third individual may use the same procedure described above to produce a visual symbol 420 based on how he/she perceives the timber components in the same sound segment that the first individual listened to for creating the visual symbol 405.

The quantization values of the second individual are different from those of the first individual. However, the overall profile of the visual symbol 415 is somewhat similar to that of the visual symbol 405. The computer may evaluate the quantization values of the two visual symbols and generate a visual symbol 410 that is based on averaging the various quantization values of the visual symbol 405 and the visual symbol 415.

In an example implementation, the averaging may be carried out on a per scale basis. Accordingly, an average value of 2 is determined for the scale 305 based on averaging a quantization value of 1 (corresponding to the visual symbol 405) and a quantization value of 3 (corresponding to the visual symbol 415) on the scale 305. An average value of 4 is determined for the scale 310 (average of 3 and 5), of 3 for the scale 315 (average of 2 and 4), of 3 for the scale 320 (average of 2 and 4), of 4.5 for the scale 325 (average of 4 and 5), and 3 for the scale 330 (average of 2 and 4). The averaged visual symbol 410 may be stored in memory and used for responding to queries such as a retrieve query and a search query. In other implementations, the visual symbol 410 may be produced by averaging quantization values submitted by more than two individuals.

The quantization values of the third individual are different from those of the first individual and the second individual. Furthermore, the overall profile of the visual symbol 420 is different in comparison to the visual symbol 405 and the visual symbol 415. The computer may evaluate the profile of the visual symbol 420 and determine that the visual symbol 420 is an outlier that should be omitted when executing the averaging procedure described above.

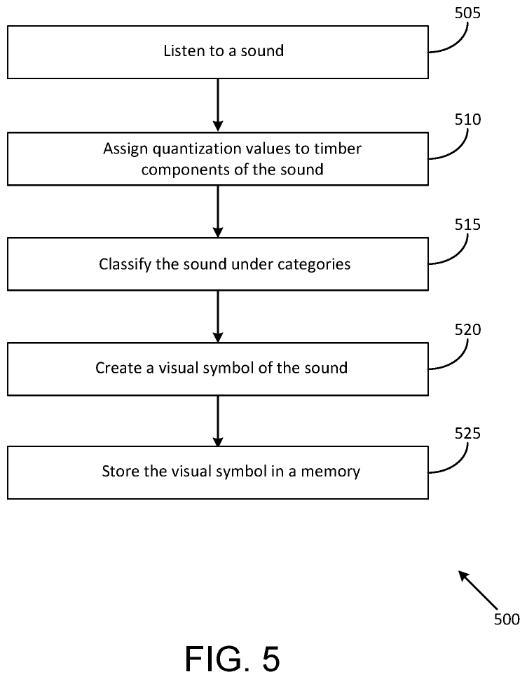

FIG. 5 shows a flowchart 500 of a method to generate a visual symbol of a sound in accordance with an embodiment of the disclosure. The flowchart 500 illustrates a sequence of operations that can be implemented in hardware, software, or a combination thereof. In the context of software, the operations represent computer-executable instructions stored on one or more non-transitory computer-readable media such as a memory in a computer, that, when executed by one or more processors such as a processor in the computer, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel.

At block 505, one or more individuals listen to a sound. Each individual may perceive various attributes of the sound in various ways. The perceptions may vary due to a variety of factors such as, for example, a hearing capability of an individual (a younger person may hear sounds extending over a broader frequency range than an older person), an analytical capability of an individual (an engineer may perceive sound in a different way than an artist), an attentivity of an individual (an adult may have more focus than a teenager, for example), a musical skill/background of an individual (a musician may recognize tonal qualities that may not be recognizable by a non-musician), and so on. The various sound attributes are referred to herein as psychological stimulants of the sound.

At block 510, the listener(s) assign quantization values to the various psychological stimulants. Any number of psychological stimulants may be assigned the quantization values. In an example implementation, the listener(s) assign quantization values to the various psychological stimulants by using a template such as, for example, the template 200 or the template 300 described above.

At block 515, which is optional, the sound may be classified under various categories. The classification may be based on various criteria such as, for example, based on search considerations when searching a memory for a sound having a particular psychological stimulant. As one example, a sound may be classified as a vehicle sound, so as to allow for a search of the sound (or other sounds) having a psychological stimulant that may be associated with vehicular sounds (a closing door, a chime, etc.).

At block 520, a visual symbol of the sound may be created. In an example implementation, the visual symbol may be created from a graphical representation produced on a template. An example visual symbol 410 that is described above may be produced by averaging quantization values submitted by two or more individuals.

At block 525, the visual symbol may be stored in a memory. In an example implementation, a visual symbol may be stored as a set of numerical values (digital bits). In another example implementation, a visual symbol may be stored as coordinate values for generating the visual symbol on a display screen. In yet another example implementation, a visual symbol may be stored as a file. The file may include a file name and other attributes that render the file more amenable for a search (for example, a file extension, or metadata).

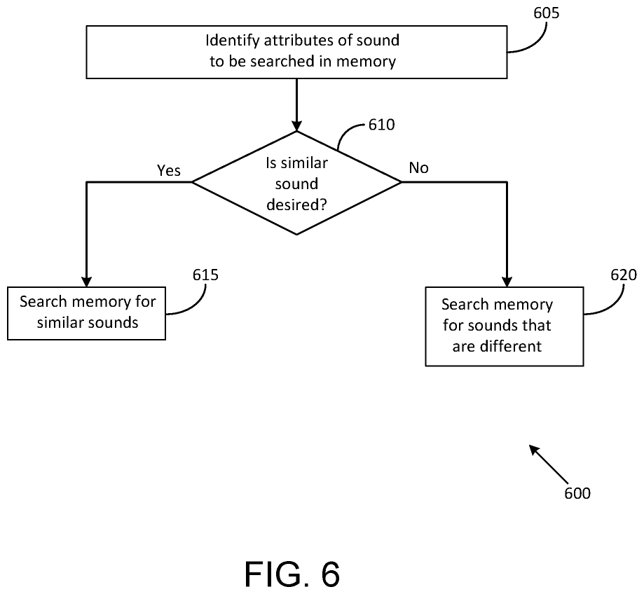

FIG. 6 shows a flowchart 600 of a method to search a memory for a visual symbol of a sound in accordance with an embodiment of the disclosure. In some cases, the memory may be configured as a database for storing visual symbols and associated information. At block 605, various attributes of the sound may be identified. If the sound is a vehicular sound (a sound of a door chime, for example), an identification of various psychological stimulants such as, for example, a harmonic psychological stimulant, a mellow timer component, an energetic timer component, a rhythmic psychological stimulant, or a strident psychological stimulant may be made. The identification may be based on a desired type of sound quality for the door chime. In one case, it may be desired to operate the chime in the form of a gentle unobtrusive reminder. In another case, it may be desired to operate the chime in the form of a strident, demanding warning.

A block 610, a determination is made whether it is desired to search the memory for a sound that either matches, or is substantially similar to, a sound that is designated by a specific visual symbol.

If it is desired to locate a sound that either matches, or is substantially similar to, a sound that is designated by a specific visual symbol, at block 615, a search may be initiated by querying the memory in which various visual symbols may be stored. When the memory is configured as a database, the search may be conducted by using database type queries. In some cases, the query may be directed at locating one or more visual symbols that are an exact match to visual symbol parameters defined in the query. In some other cases, the query may be directed at locating one or more visual symbols having similar visual symbol parameters as defined in the query.

In an example implementation, the visual symbols stored in memory may be configured in the form of a palette. The palette may be defined by identifying and grouping two or more sounds that share some type of similarity. The similarity may be based on various criteria such as, for example, based on an environment (such as, for example, sounds associated with a vehicle), based on shared characteristics (mellow sounds, rhythmic sounds, natural sounds, etc.), based on proprietary interests (such as, for example, sounds that may be uniquely associated with a manufacturer, a product, or a brand), and degree of difference between two sounds.

In an example implementation, the degree of difference between two sounds may be specified using numerical parameters such as, for example, a tolerance value or a statistical parameter (deviation, median value, etc.). Thus, for example, similar sounds may be specified as sounds having psychological stimulants that have a 10% tolerance with respect to the numerical values of the psychological stimulants of the visual symbol 410 described above (and shown in FIG. 4).

If it is determined at block 610 that it is desired to search the memory for a sound that is not similar to a sound designated by a specific visual symbol, at block 620, a search may be executed by using a query that can indicate one or more preferred psychological stimulants in a sound. For example, a query may be directed at locating one or more sounds having an ambient psychological stimulant ranging from about 1 to about 6 on the scale 220 of the template 200 and/or a mellow psychological stimulant ranging from about 1 to about 6 on scale 225 of the template 200.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “example implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device can include any one memory element or a combination of volatile memory elements (e.g., random-access memory (RAM, such as DRAM, SRAM, SDRAM, etc.) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced with many types of computers such as, for example, personal computers, desktop computers, laptop computers, message processors, user devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
identifying a first sound;
assigning a first quantization value to a first psychological stimulant present in the first sound;
assigning a second quantization value to a second psychological stimulant in the first sound;
producing a first graphical representation comprising the first quantization value and the second quantization value; and
creating a first visual symbol of the first sound based at least in part on the first graphical representation, wherein the first visual symbol is created further based at least in part on a first average quantization value associated with the first psychological stimulant and a second average quantization value associated with the second psychological stimulant.

2. The method of claim 1, wherein the first psychological stimulant is perceived to be at least one of a natural sound component, an artificial sound component, a harmonic sound component, a dissonant sound component, an energetic sound component, or a mellow sound component, and wherein a plurality of psychological stimulants associated with the first sound comprises the first psychological stimulant and the second psychological stimulant, and wherein a number of psychological stimulants associated with the plurality of psychological stimulants is determined based on a number of sound sources associated with the first sound.

3. The method of claim 1, wherein the first quantization value is a first numerical value that is selected from an assigned range of numerical values, the second quantization value is a second numerical value that is selected from the assigned range of numerical values, and the first graphical representation comprises one of a first line segment or a first curve segment that connects the first numerical value to the second numerical value.

4. The method of claim 3, further comprising:
displaying a numerical template comprising a first scale and a second scale;
assigning the first numerical value upon the first scale; and
assigning the second numerical value upon the second scale.

5. The method of claim 3, further comprising:
identifying a second sound;
assigning a third quantization value to the first psychological stimulant in the second sound;
assigning a fourth quantization value to the second psychological stimulant in the second sound;
producing a second graphical representation comprising the third quantization value and the fourth quantization value; and
creating a second visual symbol of the second sound based at least in part on the second graphical representation, wherein the second visual symbol is created further based at least in part on a third average quantization value associated with the first psychological stimulant and a fourth average quantization value associated with the second psychological stimulant.

6. The method of claim 5, wherein the third quantization value is a third numerical value in the assigned range of numerical values, the fourth quantization value is a fourth numerical value in the assigned range of numerical values, and the second graphical representation comprises one of a second line segment or a second curve segment that connects the third numerical value to the fourth numerical value, and wherein the method further comprises:
storing the first visual symbol and the second visual symbol in a memory; and
retrieving one of the first graphical representation or the second graphical representation based on a query comprising a sound having a degree of difference within a tolerance value of the first visual symbol or the second visual symbol.

7. The method of claim 1, wherein assigning the first quantization value to the first psychological stimulant in the first sound comprises quantifying a first perceived sound quality of the first sound and assigning the second quantization value to the second psychological stimulant in the first sound comprises quantifying a second perceived sound quality of the first sound.

8. The method of claim 1, wherein assigning the first quantization value to the first psychological stimulant is based on determining an average of a first set of quantization values provided by a set of individuals listening to the first sound, and wherein assigning the second quantization value to the second psychological stimulant is based on determining an average of a second set of quantization values provided by the set of individuals listening to the first sound.

9. A method comprising:
assigning a first quantization value to a first psychological stimulant in a first sound that is associated with a vehicle;
assigning a second quantization value to a second psychological stimulant in the first sound that is associated with the vehicle;
producing a first graphical representation comprising the first quantization value and the second quantization value; and
creating a first visual symbol of the first sound associated with the vehicle based at least in part on the first graphical representation, wherein the first visual symbol is created further based at least in part on a first average quantization value associated with the first psychological stimulant and a second average quantization value associated with the second psychological stimulant.

10. The method of claim 9, wherein the first sound is produced by a door of the vehicle, a horn of the vehicle, a sound system of the vehicle, and/or an engine of the vehicle.

11. The method of claim 9, wherein assigning the first quantization value to the first psychological stimulant is based on determining an average of a first set of quantization values provided by a set of individuals listening to the first sound, and wherein assigning the second quantization value to the second psychological stimulant is based on determining an average of a second set of quantization values provided by the set of individuals listening to the first sound.

12. The method of claim 9, wherein the first quantization value is a first numerical value that is selected from an assigned range of numerical values, the second quantization value is a second numerical value that is selected from the assigned range of numerical values, and the first graphical representation comprises one of a first line segment or a first curve segment that connects the first numerical value to the second numerical value.

13. The method of claim 12, further comprising:
assigning a third quantization value to the first psychological stimulant in a second sound that is associated with the vehicle;
assigning a fourth quantization value to the second psychological stimulant in the second sound that is associated with the vehicle;
producing a second graphical representation comprising the third quantization value and the fourth quantization value; and
creating a second visual symbol of the second sound associated with the vehicle based at least in part on the second graphical representation, wherein the second visual symbol is created further based at least in part on a third average quantization value associated with the first psychological stimulant and a fourth average quantization value associated with the second psychological stimulant.

14. The method of claim 13, wherein the third quantization value is a third numerical value in the assigned range of numerical values, the fourth quantization value is a fourth numerical value in the assigned range of numerical values, and the second graphical representation comprises one of a second line segment or a second curve segment that connects the third numerical value to the fourth numerical value, and wherein the method further comprises:
storing the first visual symbol and the second visual symbol in a memory; and
retrieving one of the first graphical representation or the second graphical representation based on a query comprising a sound having a degree of difference within a tolerance value of the first visual symbol or the second visual symbol.

15. An apparatus comprising:
a memory that stores computer-executable instructions; and
a processor configured to access the memory and execute the computer-executable instructions to perform operations comprising:
receiving a first user input that indicates assigning of a first quantization value to a first psychological stimulant in a first sound;
receiving a second user input that indicates assigning of a second quantization value to a second psychological stimulant in the first sound;
producing a first graphical representation comprising the first quantization value and the second quantization value;
creating a first visual symbol of the first sound based at least in part on the first graphical representation, wherein the first visual symbol is created further based at least in part on a first average quantization value associated with the first psychological stimulant and a second average quantization value associated with the second psychological stimulant; and
storing the first visual symbol in the memory.

16. The apparatus of claim 15, wherein the processor is further configured to access the memory and execute the computer-executable instructions to perform operations comprising:
receiving a third user input that indicates assigning of a third quantization value to a third psychological stimulant in a second sound;
receiving a fourth user input that indicates assigning of a fourth quantization value to a fourth psychological stimulant in the second sound;
producing a second graphical representation comprising the third quantization value and the fourth quantization value;
creating a second visual symbol of the second sound based at least in part on the second graphical representation, wherein the second visual symbol is created further based at least in part on a third average quantization value associated with the first psychological stimulant and a fourth average quantization value associated with the second psychological stimulant; and
storing the second visual symbol in the memory.

17. The apparatus of claim 15, wherein the processor is further configured to access the memory and execute the computer-executable instructions to perform operations comprising:
receiving a query comprising a sound having a degree of difference within a tolerance value of the first visual symbol; and
retrieving the first visual symbol from memory in response to the query.

18. The apparatus of claim 15, wherein the apparatus further includes a display screen and the processor is further configured to access the memory and execute the computer-executable instructions to perform operations comprising:
displaying upon the display screen, a template comprising a first scale and a second scale;
receiving the first user input as a first numerical value that is selected from a range of numerical values displayed on the first scale; and
receiving the second user input as a second numerical value that is selected from the range of numerical values displayed on the second scale.

19. The apparatus of claim 18, wherein the processor is further configured to access the memory and execute the computer-executable instructions to perform operations comprising:
producing the first graphical representation by including one of a first line segment or a first curve segment that connects the first numerical value to the second numerical value.

20. The apparatus of claim 18, wherein the range of numerical values extends from a first number that represents one of a natural sound component, a harmonic sound component, or an energetic sound component, to a second number that represents a respective one of an artificial sound component, a dissonant sound component, or a mellow sound component, and wherein a plurality of psychological stimulants associated with the first sound comprises the first psychological stimulant and the second psychological stimulant, and wherein a number of psychological stimulants associated with the plurality of psychological stimulants is determined based on a number of sound sources associated with the first sound.
